(19) United States
(12) Patent Application Publication
(10) Pub. No.: US 2015/0354543 A1
(43) Pub. Date: Dec. 10, 2015

(54) Floating Wind Turbine Structure

(71) Applicant: Hans Seternes, Trondheim (NO)

(72) Inventor: Hans Seternes, Trondheim (NO)

(21) Appl. No.: 14/760,212

(22) PCT Filed: Oct. 1, 2013
(86) PCT No.: PCT/NO2013/050165

§ 371 Date: Jul. 10, 2015

(30) Foreign Application Priority Data
Jan. 12, 2013 (NO) 20130082

(51) Int. Cl. F03D 11/04; B63B 35/44; F03D 1/06; F03D 9/00; F03D 3/06

(52) U.S. Cl. CPC F03D 11/04; F03D 9/008; F03D 9/002; F03D 9/001; F03D 3/061; F03D 1/065; B63B 35/44; B63B 2035/446

(57) ABSTRACT

Floating wind turbine structure comprising a socket provided with one or more anchorings to the seabed to support one or more wind turbines connected to a driving motor or power generator. The wind turbine is arranged upon a substantially triangular floater device consisting of hollow pipes extending downwards into the sea at a mutual angle and increasing mutual distance in direction downwards. A hollow arc-shaped underpart/cross piece is arranged at the lower end of the floater device pipes. A strutting piece is arranged at the upper part of the floater device. The cross piece is partially filled by liquid and its internal is provided with a flow restricting plate which decelerates liquid flow from one end to the other of the cross piece during increasing and decreasing heeling.

### BACKGROUND

The disclosure concerns a floating wind turbine structure. A floating wind turbine is a wind turbine mounted on a floating structure located in the sea, generally in deep sea, to allow the turbine to generate electricity at sea depths where bases mounted on the seabed cannot be used. Wind turbine farms located far out into the ocean has the advantage that a visual pollution can be reduced and provides a better adaptation for fishing and fairways. Another advantage is that the wind is generally stronger far out into the ocean and provides a potentially increased production of electricity per unit.

An example of a known floating wind turbine assembly is the Hywind concept by Statoil. The floating structure consists of a steel cylinder which is filled with a ballast of water and rocks. It extends 100 meters below the sea surface and is anchored to the seabed by three anchors. The object is to provide a competitive sea based windmill concept which can be located at deep sea close to the markets.

A disadvantage of constructions of this type is that the propellers are provided with an expensive and complicated torsion controller (pitch controller) to enable torsion of the wings at increasing wind load to reduce the risk of damage or failure. The floating structure makes sure that the wind turbine remains in substantially the same vertical position even in extremely strong wind with an accompanying risk of failure.

As mentioned above, a disadvantage of prior art wind turbines with a wind-affected rotor in the form of three propeller blades mounted to a rotary shaft is that they must be provided with torsion controller in order to control the torsion angle of the respective propeller wing at varying wind. This makes the construction more expensive, results in a higher number of construction details and a higher demand for maintenance to keep the wind turbine in operation. In extremely strong wind, such as strong storm and hurricane, the wind turbines must be shut down completely and the propellers must be locked to prevent incidence of damage or failure on the shaft section of the wind turbine, such as wing breakage.

Viewed against the background of the today's resistance against unethical wind mills with expensive assembly and maintenance, where for example very heavy generators are elevated about 100 meters from the ground into a constricted compartment, or when a propeller wing weighing several tons is damaged or broken, it is risky to humans and it is not a simple or cost-effective task to replace it. The high peripheral speed of the wings prevents an increased rotational speed and requires a complicated control. Another disadvantage is that such large propeller wings pollute the environments visually, make noise and kill birds, and prevents use of helicopters (offshore).

From U.S. Pat. No. 1,816,971 A it is known a screw-shaped turbine having a shaft-shaped rotary part provided with screw-shaped wings mounted within a conical cover having openings in both ends where fluid may flow from one end to the other and force the rotary part to rotate. However, this construction is not suitable for use in wind turbines because of large pressure drop and low power efficiency.

DE Patent publication No. 2 935 803 A1 describes a spiral-shaped wind loaded wing mounted on a rotary shaft for use with wind turbines. The wings are conical along the rotary shaft. This construction will provide less pressure drop than the construction described in U.S. Pat. No. 1,816,971 A, but will result in turbulent flow behind parts of the spiral wings and lacks a more optimal utilization of the wind energy. A similar construction is described in DE Patent publication No. 197 01 048 A1.

### SUMMARY

It would be useful to have a wind turbine which is able to withstand the forces from extreme wind without damage. It would also be useful to have a propeller based wind turbine which does not add costs and does not complicate torsioning for the rotor blades. It would also be useful to provide a floating wind turbine which simplifies transport and maintenance offshore.

Disclosed herein is a floating wind turbine assembly comprising one or more wind turbines arranged up in one or more floating devices, each provided in the form of a hollow substantially triangularly shaped floating structure formed of two hollow elongate structures (legs) extending down into the sea at a mutual increasing distance in direction downwards and are in the underpart mutually connected by an underpart/cross piece. Each leg can be filled with and drained with liquid, such as seawater or fresh water, by one or more pumps. The respective legs can be filled and drained independently of each other. In this way, the floating depth of the wind turbine assembly in the water can be adjusted and it can be forced to heel by filling one of the legs with liquid and draining the other. The underpart of the triangularly shaped floating device contains liquid which can flow from one end to the other during heeling. A flow restricting device is preferably arranged within the hollow part—also denoted as cross piece or underpart—to limit the water flow. The underpart is preferably also a bit arc formed. This design provides a particularly advantageous dampening effect, which is explained in further detail below. The present wind turbine assembly will heel in the see in extremely strong wind to control and limit the wind load on the structure as a whole. This is particularly advantageous for traditional wind turbines of the propeller type.

The turbine part per se of the wind turbine structure of the invention may be a traditional turbine of the propeller type, but the present disclosed turbine assembly does not require any complicating torsion mechanism adding expenses to retard/lock the propellers at extremely strong wind.

In an alternative embodiment, the wind turbine is realized in the form of one or more rotary wings arranged at an tilted shaft supported rotary and in power connection with e.g. a power generator. The rotary wings are arranged within a flow channel, which at the inlet side is formed as a wedge-shaped trough, which at the outlet end is shaped as a conical diffuser. This is described in further detail below. This structure will accelerate air into the rotary wings and increase the flow rate further in the power producing part. Moreover, the conical diffuser will create an underpressure at the outlet end and further reinforce the accelerating effect. Another advantage of a construction of this type is that the rotors have a substantially less periphery and may obtain a substantially higher rotary speed than traditional propeller turbines. Yet another advantage of the present wind turbine is that the risk of failure and dismantling of structural components during extremely strong wind is reduced or eliminated.

The disclosed turbine assembly has no pitch control or heavy machinery at high elevations. The nature itself controls the load on the turbine through its wind force, and it is protected from the harmful wind forces. This centrally open and self-controlled turbine assembly exhibit a relatively large wing area located along the periphery of the screw, which results in a homogenous and strong torque transferred to a drive shaft, e.g. via spokes such as in the rim of a bike, and in addition, a flow-favorable opening in the middle. At favorable parameter settings, this device/assembly is suitable for increased wind speeds to the “free wind”, from a large outlet area, and will by means of pressure difference through the wedge trough and diffuser create higher wind speed, where an increased effect is obtained at the upper end of the trough—and laminar flow but nevertheless satisfying an optimum residual speed of about ⅓V behind the turbine. Because of the relatively low peripheral speed, it is possible to let this turbine run freely without frequency control, the current is rectified and transferred via a cable at lower loss, followed by inversion at the consumer site. The assembly can utilize wind speed of more than 11-12 meters/second, which is the maximum wind speed for most propeller turbines (they are controlled down to that frequency). An increase to only 16-17 m/s will provide more than 3 times more effect, and here the floater of the present assembly is activated by wind controlled heeling which protects the turbine against the harmful wind forces at extreme weather. The torque can also be increased by a larger thread pitch, or one or more parallel pitch/pitch elements being mutually distributed along the shaft. Warm air rising upwards from the generator room will, because of the chimney effect, rise up through cavities in wing, wedge-shaped trough and skirt, and thus prevent ice formation. The environmental aspect is also ensured by nearly invisible rotation, low noise level and low possibility of bird damage.

This is in accordance with the invention obtained in that a wind-affected wedge-shaped trough with diffuser having a wide inlet opening, increases the wind speed by means of lower pressure in diffuser, the fast-flowing medium is guided to a concentrically adapted, centrally open, screw-shaped rotary wing, exhibiting more than 1 pitch revolution, and which is attached to a shaft, suspended between an upper bearing in the top and generator/drive engine at the bottom. The rotor and the trough are attached at the top of a heeling controlled floater, where wind-affected heeling provides an optimum effect when the surface of the wing profile is nearly parallel with incoming wind direction at the wind end of the turbine, and that maximum heeling provides reduced effect on the rotary wing and protection during storm and hurricane. Moreover, the heeling across an angle interval is controlled by a ballast/liquid flow through an adapted dampening opening for liquid.

The fluctuation characteristics of the triangularly-shaped pipe structure having a skid-like lower section, is arranged in such a manner at it at reduced wind fluctuates back to the starting point, like a rocking chair. An additional control here is that the floater also is controllable during towing or at a shipyard, outside the fluctuating system, by pumping liquid from one leg to the other.

The wing torque on the shaft has been increased at a periphery-located wing area, and is increased further by changing pitch or insert one or more parallel wings. The power production can be increased by up-scaling or by adding more turbine modules. The low periphery speed of the device can be used to increase the rotary speed. The periphery-located wing utilizes the power from the same flow particle more than once, before it leaves the turbine wing. Parameters such as torsion angle, conical angle, center opening, pitch, wing width and wing profile, are not bound to any fixed value or shape along the length of the shaft. The peripherally located wing friction resistance/energy loss is caused by the advantageous axial peripheral speed, and not by the unfavorable radial one. The gentle speed does not harm birds. Cavities in wing, wedge-shaped trough, and skirt, are arranged for upwards rising warm air from the generator room to prevent ice formation. The pitch/thread direction of the turbine (right/left) is dependent on flow symmetry at a multiple-turbine plant. The turbine is applicable both in liquid, gas and/or as particle pump, and is also environmentally designed. The device is suitable for helicopter transport, is service friendly, may be assembled at pier. It is no longer necessary to perform weather-affected and risky assembly operations and expensive lifting vessels out on the ocean.

The floater also controls propeller turbines. This is in accordance with the invention achieved in that at least one wind-loaded propeller device in a flow-favorable formation is attached at the top of a heeling controlled floater, where wind-affected heeling near the top provides the propeller with highest effect and reduced effect at maximum heeling, which provides the propeller with protection during storm and hurricane. Moreover, the heeling occurs within an angle range controlled by ballast/liquid flow through an adapted dampening aperture, and in that the oscillating characteristics of the triangle, having an arc-shaped lower pipe, is arranged in such a manner that it at weaker wind returns back to the starting point, like a rocking chair. More service-friendly heeling is obtained by pumping liquid from one leg to the other. The device will, during the heeling obtain less wind load at decreasing height, increasing tilting of propeller, including a more tilted and wind dampening helicopter platform.

Present pitch control (wing torsioning) can now be replaced by wind-affected heeling control. Weather load on tower and propeller is reduced during periods with very strong wind.

The device is suitable for helicopter transport, is service friendly, can be assembled in the port, weather exposed and dangerous assembly jobs and expensive lifting vessels in the sea are no longer required.

The helicopter platform is designed for optimal wind deceleration and will therefore also contribute in shielding the propeller against wind load. The platform attains an advantageous wind protecting tilted position during periods with bad weather, storm and hurricane.

### BRIEF DESCRIPTION OF THE DRAWINGS

The disclosed device is in the following described in further detail by means of drawings illustrating embodiments of the invention, where

FIG. 1 illustrates a screw turbine in perspective from above in accordance with an embodiment of the invention,

FIG. 2 is a drawing similar to FIG. 1, but viewed more from the front and having two rotary wings and having a little different design of the wedge-shaped trough and diffuser,

FIG. 3A illustrates a wind turbine device in accordance with the invention located in the sea during normal operation, whereas

FIG. 3B illustrates a wind turbine device in accordance with the invention at extreme wind load,

FIG. 4 illustrates FIG. 3A in the wind direction having four rotary wings,

FIG. 5 shows parts of the floater device of the wind turbine device in accordance with the invention, partly sectioned, viewed from the side,

FIG. 6 shows a wind turbine device in accordance with the invention anchored in the port for maintenance,

FIG. 7 shows a wind turbine device in accordance with the invention during towing,

FIG. 8A and 8B are drawings similar to FIG. 3A and 3B, respectively, but viewed in perspective,

FIG. 9 is a drawing similar to FIG. 8A and 8B but where the wind turbine part is a traditional propeller-operated turbine,

FIGS. 10 and 11 are drawings similar to FIGS. 6 and 7, respectively, but where the wind turbine part is a traditional propeller-operated turbine,

FIG. 12 shows an alternative embodiment of the wind turbine device in accordance with the invention with two traditional propeller-operated turbines and with a helicopter deck, and

FIG. 13A, 13B and 14 illustrate an alternative embodiment of the wind turbine assembly in accordance with the invention having a floating wave-power plant arranged at one of the legs of the floater device of the wind turbine structure.

### DETAILED DESCRIPTION

FIG. 1 shows a screw turbine in perspective from above in accordance with an embodiment of the disclosure having one single rotary wing 30 arranged on a rotary shaft 31. The rotary shaft is in its upper end supported rotary in a bearing 33 and in the lower end 32 connected in a rotary and power-transmitting manner with a generator (not shown) arranged in a compartment below the wind turbine. These are details which are considered to be familiar to a person skilled in the art and are not discussed in further detail here. A screw-shaped rotor blade 30 is arranged on a rotary shaft 31. The rotary shaft is arranged slightly tilted in direction upwards. The rotor blade 33 is arranged within a substantially closed flow channel 3 having an inlet end 2 formed like a wedge-shaped trough. The wedge-shaped trough 2 exhibits a lower edge 2′ which constitutes the extreme end of the inlet part and an upper edge 2″ located further in towards the middle part of the wind turbine. Then the inlet part 2 exhibits a wedge-shaped trough having a spade or shovel-shaped underpart but changing into a closed flow channel 3 closer to the middle of the turbine. The outlet part 4 of the turbine is cone-shaped having an increasing flow cross-section in the flow direction and is also denoted as a diffuser. The angle of tilt of the longitudinal axis in the flow direction of the flow channel 3 with the rotor blades 33 extend at an angle of 0-33 degrees to the horizontal level, in particular about 15-30 degrees and preferably about 25 degrees, when the wind turbine structure is floating freely in the sea without noticeable wind influence, so that they at extreme wind load extend substantially horizontally to the sea surface.

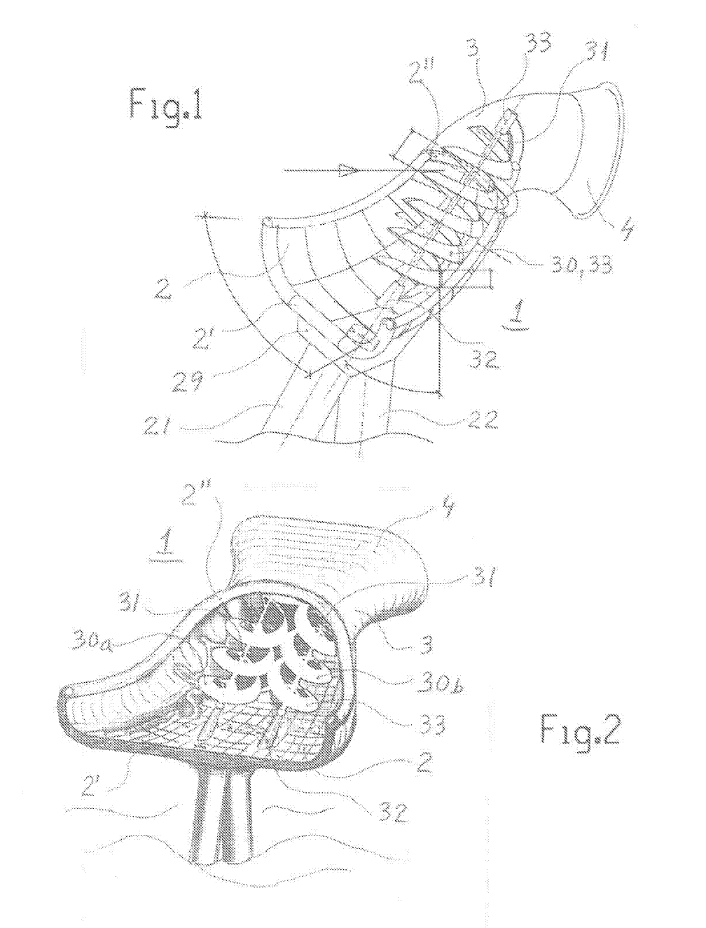

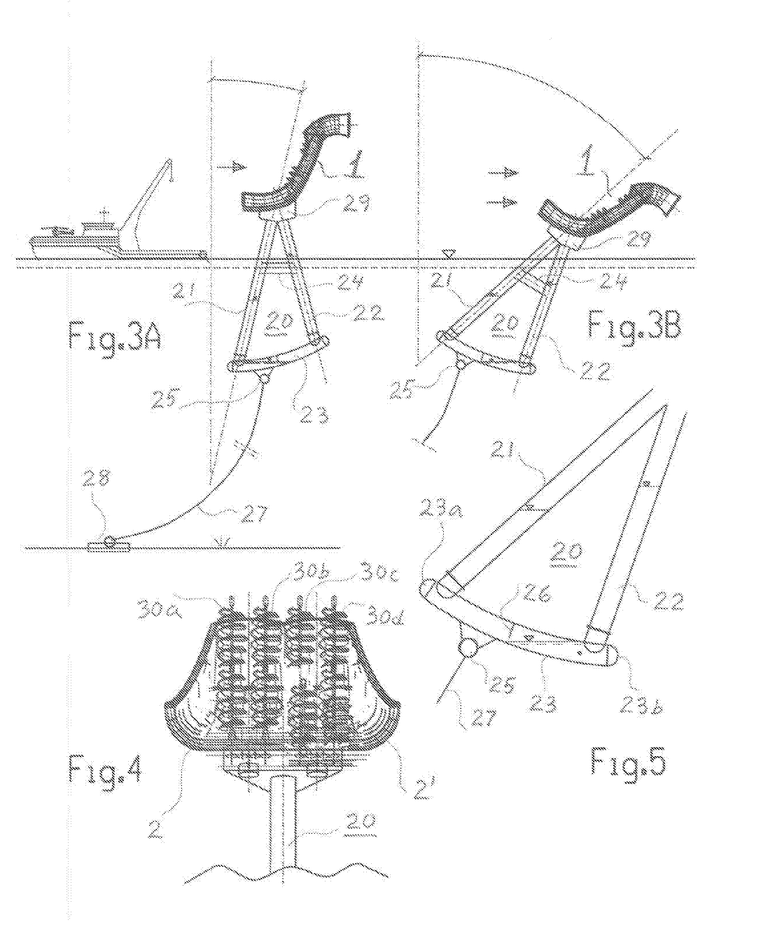

FIG. 2 is a drawing similar to FIG. 1 but viewed more from the front and having two rotor blades 30a and 30b and having a slightly different design of wedge-shaped trough and diffuser 4. A similar construction is illustrated in FIG. 4 but with a total of four rotor wings 30a, 30b, 30c and 30d.

Now referring to FIG. 3A, 3B, 5, 6, 7, 8A and 8B, the wind turbine device is illustrated arranged in the sea. The turbine 1 is arranged on a triangularly shaped floater device 20 with an upper attachment device 29 for attachment of one or more wind turbines, and optionally a helicopter deck. The floater device 20 comprises two pipe-shaped legs 21 and 22 extending at a mutual angle downwards from the attachment device 29 and at increasing mutual distance in direction downwards. An underpart or cross piece 23 is at its ends connected to the lower end of the legs 21 and 22. The cross piece 23 is advantageously arc-shaped with a “circle”-center located above the cross piece, so that the middle part of the cross piece constitutes the lowest point of the floater device when floating freely and without load in the sea. The radius of curvature depends of the desired degree of heeling resistance or oscillation frequency and must be contemplated in combination with the dimensions and weight of the remaining part of the structure. The wind turbine structure is anchored to an anchoring device comprising an anchor 28 and an anchor cable 27 connected to a swivel 25 connected to the cross piece 23. This is per se known from the prior art and is not described further here. A strutting 24 is preferably fixedly connected between the legs 21 and 22 to reinforce the structure further against load from wind and sea.

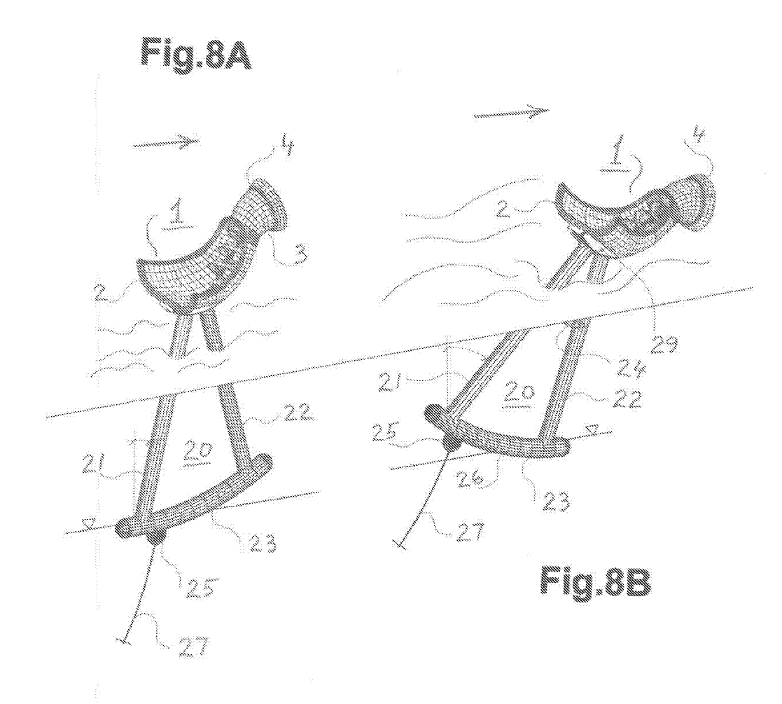

Still with reference to the drawings as described in the paragraph above, the cross piece or underpart 23 is partly filled by liquid. A flow-restricting device, such as a plate 26, covers a part of the flow cross-section within the underpart 23. This provides a dampening effect of the oscillating motion of the structure as a whole from load from wind, waves and current and prevents an excessive heeling from one side to another. FIG. 3A and 8A illustrates the wind turbine structure during normal operation where water float freely within one end of the underpart 23 (left hand in the drawings). FIG. 3B and 8B show the wind turbine structure in strong wind and heeling down into the sea and shielding the wind turbine against wind load.

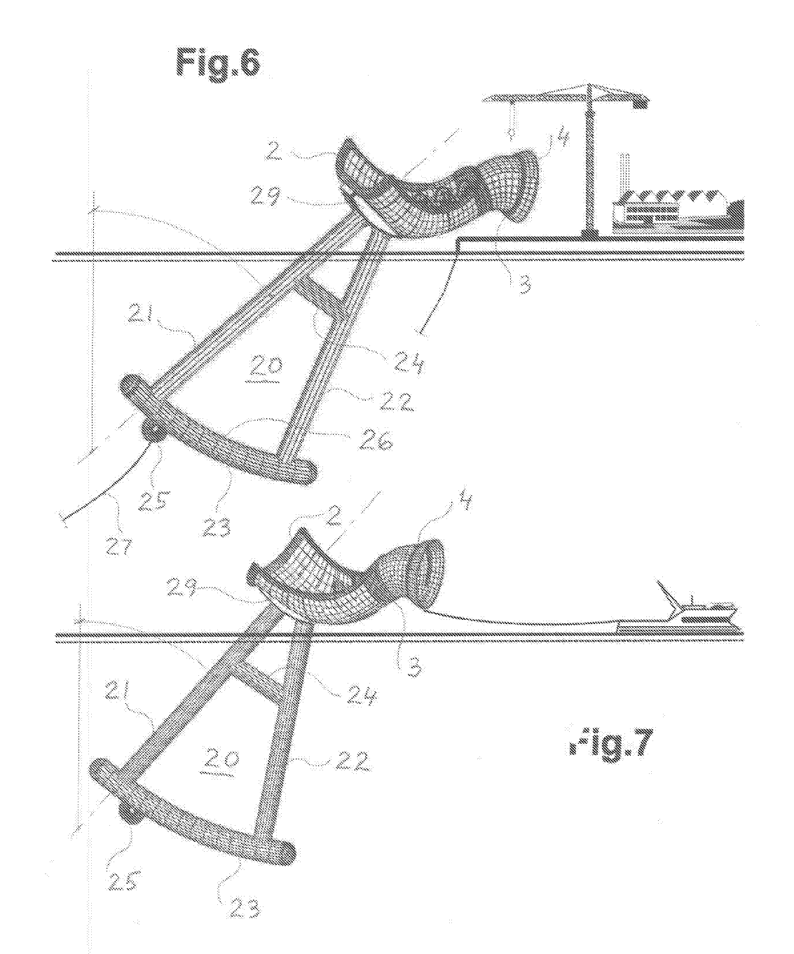

FIGS. 6 and 7 show the wind turbine structure where the internal of one of the legs 21 is partly or completely released from liquid, whereas the internal of the other leg 22 is partly or completely filled with water to force the structure as a whole down into the sea. FIG. 6 shows schematically a condition like this where the turbine is arranged for maintenance at a land based workshop, whereas FIG. 7 illustrates the wind turbine structure arranged for towing. The water distribution is provided by one or more pumps (not shown), e.g., arranged in the generator compartment of the wind turbine. The arrangement of pumping water from one leg to the other is considered to be within the reach of a person skilled in the art and is not described further here.

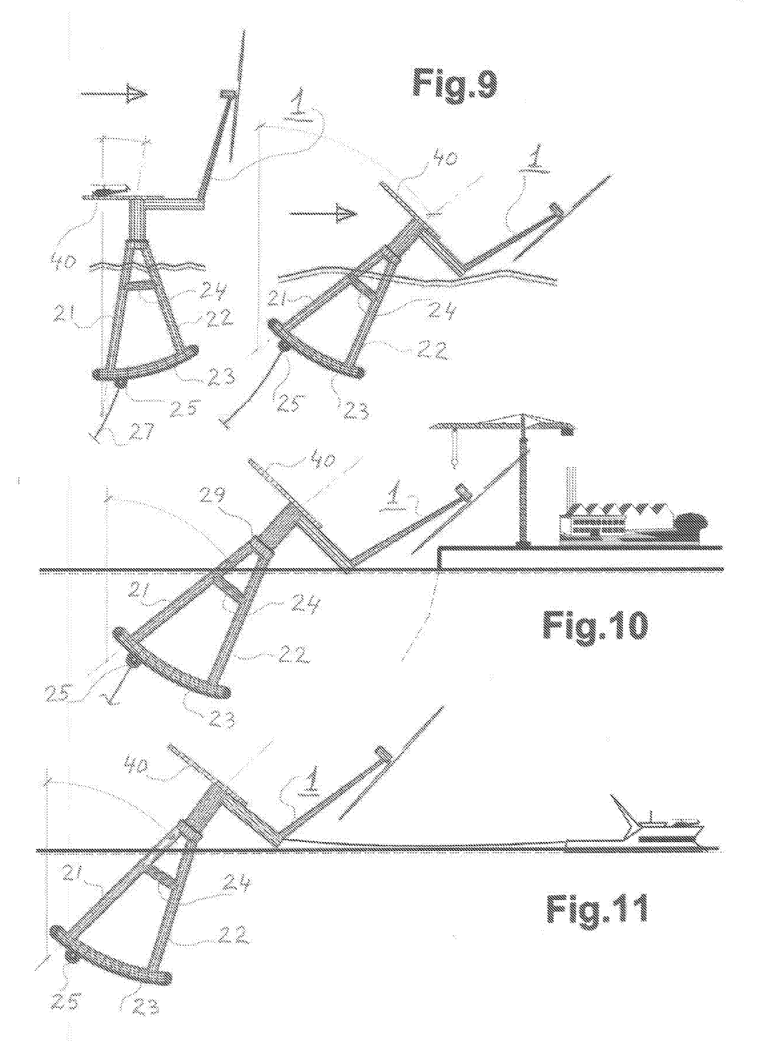

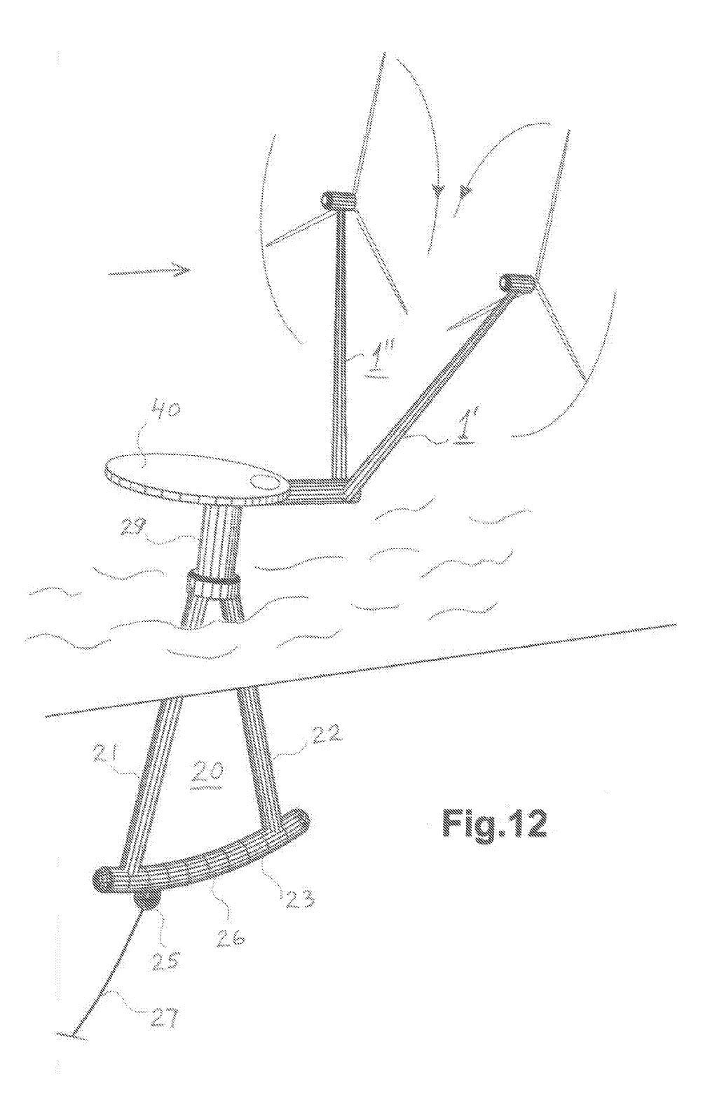

FIGS. 9, 10 and 11 illustrate an alternative design of the wind turbine per se of a traditional wind turbine of the propeller type. These drawings can in part be compared with FIG. 12, but where the latter explicitly illustrates a wind turbine consisting of two juxtaposed wind turbines of the propeller type. A helicopter deck is illustrated at reference number 40. As can be seen from the right hand part of FIG. 9, the structure as a whole will be heeling down into the sea during extremely strong wind, and will by itself provide a decreased wind load since the propeller blades are oriented at an angle to the wind direction which is increasing by increasing wind. The helicopter deck will simplify access to the structure for maintenance. Another advantage of the helicopter deck is that it will shield the propellers of the wind turbine further and decrease or even eliminate the risk of being teared apart. Towing and maintenance will function in the same manner as by the embodiment described above.

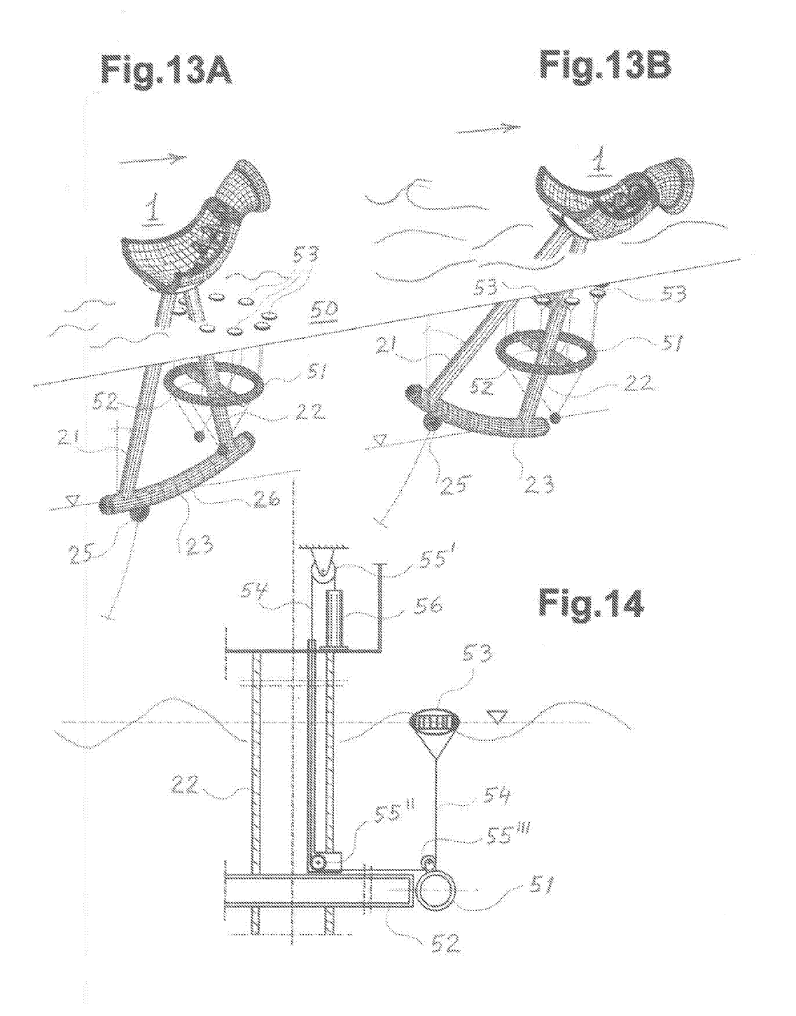

FIG. 13A, 13B and 14 illustrate an alternative embodiment of the invention where a wave power device is arranged at one of the legs 22 of the floater device of the wind turbine structure in accordance with the invention. A floating collar 51 is arranged pivotal in the vertical plane about a shaft 52 fixedly connected to said leg 22. A generator 56 located within or at the generator compartment about the sea surface at the underside of the wind turbine 1, is operated by wave force movements transferred from pontoons 53 via a wire 54 guided over pulleys 55′, 55″, 55″' arranged at the floating collar 51, the second leg 22 of the floating device and at the generator itself. FIG. 13B shows the wind turbine device during very strong wind load. Here one may see that the pontoons automatically are pulled down into the sea to protect the wave power device from strain. By arranging several smaller floating collars with accompanying pontoons distributed and suspended in the bulk water to the lower and then a bit larger floating collar 51, the “wave part” may be extended.

Whereas the description above has illustrated definite embodiments of the invention, a person skilled in the art having ordinary knowledge within the field will easily be able to deduce alternative embodiments of the present invention with support in the description and the illustrations in the drawings. In the example description, a substantially triangular floating device is described in the form of two legs with an underpart. However, it is conceivable to arrange numerous floating devices side by side, e.g. to increase buoyancy and/or decrease length of the legs. For example, the number of rotor wings and angle of tilt of the same may vary, and for example in accordance with field of use, expected wind conditions, design of flow channel of the rotor wings. Moreover, the floater device does not need to be shaped as a triangle in the form of hollow pipes. The floater device can for example be formed of hollow channels with another cross-section than circular.

1-16. (canceled)

17. A floating wind turbine structure comprising:
a socket (20) with one or more anchorages (25, 27, 28) to the seabed to support one or more wind turbines (1) connected to a driving motor or power generator, said one or more wind turbines being arranged on one or more floater devices, each comprising a first elongate hollow underpart (21) and a second elongate hollow underpart (22), whereby
the first underpart (21) and second underpart (22) are connected to an anchorage part (29) for fixing said one or more wind turbines (1), and extend relative to each other at a mutual angle with increasing mutual distance in the direction toward the seabed and are at their respective lower ends fixedly connected to an elongate hollow underpart (23), thereby providing a floating structure with a substantially triangular side profile, wherein
the elongate hollow underpart (23) is provided with a cavity sealed against the outer environment to accommodate a liquid, and a unit arranged proximate the wind turbine structure configured to supply or remove liquid from the internal of the respective underparts (21, 22), thereby adjusting the buoyancy level and heeling angle of the wind turbine structure.

18. The floating wind turbine structure of claim 17, wherein the elongate hollow underpart (23) has a portion extending between a first end (23a) and a second end (23b) and is configured to retard flow of liquid therein between the first end (23a) and second end (23b) when the structure is oscillating.

19. The floating wind turbine structure of claim 17, comprising a strutting (24) fixedly connected between the first underpart (21) and second underpart (22) to stiffen, reinforce or increase buoyancy of the floater device.

20. The floating wind turbine structure of claim 17, wherein the liquid flow is retarded via a bulkhead covering a part of the flow cross-section within the cavity of the cross piece (23).

21. The floating wind turbine structure of claim 17, wherein the elongate underparts (21, 22), the elongate hollow underpart (23) and the strutting (25) are formed of pipes.

22. The floating wind turbine structure of claim 17, wherein the elongate hollow underpart (23) is substantially arcuate in shape with a substantially circular center located above the cross piece (23) when the floating wind turbine structure is located in a body of liquid.

23. The floating wind turbine structure of claim 17, comprising a wave power generator (50) with at least one floating device (51) suspended in a connecting device (52) pivotal in a vertical plane to the elongate underpart (22), and a power generator (56) driven by vertical movement from waves transferred from pontoons (53) arranged in the surface and connected to the power generator (56) via wire (54) and pulleys (55′, 55″, 55″).

24. The floating wind turbine structure of claim 23, wherein the wires (54) of the pontoons (53) exhibit a fixed length such that they may be pulled below the surface of the body of fluid when the wind turbine structure heels under the surface, thereby protecting the device from damage.

25. The floating wind turbine structure of claim 17, wherein the wind turbine comprises one or more rotor wings (30) with a screw-shaped rotor blade (33) connected to an elongate rotary shaft (31) suspended rotary in a flow channel (3) in a drive connection with a driving engine or generator, wherein the flow channel (3) comprises a wedge-shaped inlet (2, 2′, 2″) at a high pressure end that narrows in the direction downstream thereof toward a middle portion accommodating the one or more rotor wings (30), and a wedge-shaped outlet (4) that increases in cross-section downstream from the middle portion to accelerate air flowing into the turbine and ejecting air to the outlet at a lower pressure.

26. The floating wind turbine structure of claim 25, wherein a longitudinal axis extends in the direction of the flow channel (3) with the rotor blades (33) at an angle of between 0 and 33 degrees relative to a horizontal plane when the wind turbine structure is floating freely in a body of liquid with dormant wind.

27. The floating wind turbine structure of claim 25, wherein the power generator is positioned at the underside of the flow channel (2, 3, 4) in flow connection therewith, so that warm air from the power generator may flow upwards via cavities in rotor and wall of the wedge-shaped trough.

28. The floating wind turbine structure of claim 17, wherein the wind turbine (1) comprises one or more traditional propeller-driven turbines.

29. The floating wind turbine structure of claim 28, wherein the one or more propeller-driven turbines are devoid of torsion controllers for the propellers.

30. The floating wind turbine structure of claim 17, comprising a helicopter deck (40) which defines a protective shield when the wind turbine structure is heeling.

31. The floating wind turbine structure of claim 17, the liquid is removed from or provided to the internal of the respective underparts (21, 22) via one or more pumps.
